(19) United States
(12) Patent Application Publication
(10) Pub. No.: US 2024/0290981 A1
(43) Pub. Date: Aug. 29, 2024

(54) METHOD FOR PREPARING A SOLVENT-FREE ELECTRODE AND ELECTRODE FORMULATIONS OBTAINABLE BY SAID METHOD

(71) Applicants: SAFT, LEVALLOIS PERRET (FR); AUTOMOTIVE CELLS COMPANY SE, BRUGES (FR)

(72) Inventors: André DE ALMEIDA, BORDEAUX (FR); Julien BREGER, BORDEAUX (FR)

(73) Assignees: SAFT, LEVALLOIS PERRET (FR); AUTOMOTIVE CELLS COMPANY SE, BRUGES (FR)

(21) Appl. No.: 18/571,302

(22) PCT Filed: Jun. 15, 2022
(86) PCT No.: PCT/EP2022/066388

§ 371 Date: Dec. 18, 2023

(30) Foreign Application Priority Data
Jun. 16, 2021 (FR) FR2106383

(51) Int. Cl. H01M 4/62; H01M 4/131; H01M 10/0525

(52) U.S. Cl. CPC H01M 4/623; H01M 4/131; H01M 10/0525

(57) ABSTRACT

The present application relates to fluoropolymer-based, solvent-free electrode formulations obtained by extrusion and/or comprising one or more co-binders including TPU, to electrodes containing the same and to corresponding electrochemical elements and storage cells.

### CROSS REFERENCE TO RELATED APPLICATIONS

The present application is a U.S. National Phase application under 35 U.S.C. § 371 of International Patent Application No. PCT/EP2022/066388 filed Jun. 15, 2022, which claims priority of French Patent Application No. 21 06383 filed Jun. 16, 2021. The entire contents of which are hereby incorporated by reference.

### FIELD OF THE INVENTION

The present invention relates to the field of energy storage, and more particularly to storage cells in particular of lithium type.

### BACKGROUND

The functioning of lithium storage cells is based on the reversible exchange of the lithium ion between a positive electrode and negative electrode, separated by a separator containing an electrolyte, the lithium inserting itself in the negative electrode during charge operation.

Typically, the electrodes are composed of a metal foil on which there is applied an electrode formulation composed of an active material and optionally a binder and conductive element.

With the constant increase in energy and battery needs, the production thereof needs to be improved to facilitate their industrialization, to reduce costs, and improve the impact they have on the environment.

At the current time, a very large share of the production cost of an electrode is related to the manufacturing method, in particular for Li-ion technology. The solvent used to prepare the ink (comprising active material, conductive materials, and binder) that is to be coated on the foil to produce the electrode, must be evaporated. This therefore implies the use of energy-consuming ovens.

It is additionally desirable, in an environmentally-friendly approach, to limit the use of solvents.

In an effort to remove these solvents and to reduce the production costs of electrodes, new methods called solvent-free methods are currently under development.

For example WO 2015/161289 describes an electrode composition based on polytetrafluoroethylene (PTFE) and co-binders obtained by fibrillization of the PTFE with a high shear process such as grinding by jet-milling in particular.

PTFE, when highly sheared, has the particular aspect of producing fibrils which form a network contributing towards the formation of porosities within the electrode.

Nonetheless, the jet-milling step may require batch operation, incompatible with continuous mode industrial operation. In addition, grinding by jet-milling can damage fragile active material (such as graphite for example).

### SUMMARY

There is therefore a need to provide a method that is better adapted and/or can be given easy industrial application.

The present disclosure therefore concerns a novel solvent-free route for the improved preparation of electrode formulations, intended in particular for Li-ion technology.

A first subject of the present invention is a method for preparing an electrode formulation, comprising:
preparing a pre-mix comprising an active electrode material and a fluoropolymer;
mixing the pre-mix with a co-binder;
fibrillating the mixture obtained by extrusion.

The term «fluoropolymer» such as used herein refers to fluorinated polymers in which the repeat unit is a fluorocarbon comprising multiple carbon-fluorine bonds. Among these fluoropolymers, particular mention can be made of polytetrafluoroethylene (PTFE) and derivatives thereof, in particular co-polymers thereof such as chlorofluoroethylene, perfluoroalkoxy (PFA), polychlorotrifluoroethylene (PCTFE or PTFCE), fluorinated ethylene propylene (FEP), ethylene tetrafluoroethylene or poly(ethylene-co-tetrafluoroethylene) (ETFE), polytetrafluoroethylene perfluoro methylvinylether (MFA), more particularly PTFE. Preferably, said fluoropolymers are of fibrillable type.

By «fibrillable» it is meant the types of fluoropolymers which are likely to fibrillate i.e. are able to form a network of fibers in the mixture with the pre-mix, under extrusion conditions. The types of fluoropolymers can be of different forms and/or grades.

By «pre-mix» it is meant a preliminary composition previously prepared before the addition of one or more additional ingredients; in this instance, the pre-mix comprises the mixture of the fluoropolymer and active material, and optionally a conductive element before the subsequent addition of the co-binder. The pre-mix may also comprise one or more optional additives such as lubricants. For batteries with a solid electrolyte, the pre-mix may also comprise particles of solid electrolyte.

The active electrode material can be chosen from among electrochemically active materials. It is dependent on the type of electrode (positive or negative) and the type of battery under consideration.

In the case of lithium batteries, the negative active electrode material in particular is graphite, silicon, lithium, a lithium alloy or lithiophilic materials, alone or in a mixture, such as mixed SiOx/graphite active materials. The expression «lithiophilic» being defined herein as a material having affinity for lithium, i.e. the ability to form alloys with lithium, such as silicon, silver, zinc, and magnesium.

The following active materials can also be cited:
a titanium and niobium oxide TNO having the formula:

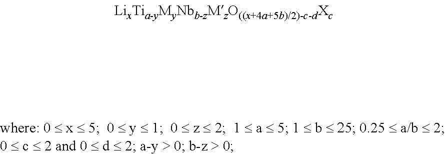

M and M′ each being at least one element chosen from the group composed of Li, Na, K, Mg, Ca, B, Sc, Ti, V, Cr, Mn, Fe, Co, Ni, Cu, Zn, Al, Y, Zr, Nb, Mo, Ru, Ag, Sn, Sb, Ta, W, Bi, La, Pr, Eu, Nd and Sm;
X is at least one element chosen from the group formed by S, F, Cl and Br.

The subscript d represents an oxygen vacancy. The subscript d can be lower than or equal to 0.5.

Said at least one titanium and niobium oxide can be chosen from among TiNb₂O₇, Ti₂Nb₂O and Ti₂Nb₁₀O₂₉.
a lithiated titanium oxide or a titanium oxide capable of being lithiated. LTO is chosen from among the following oxides:

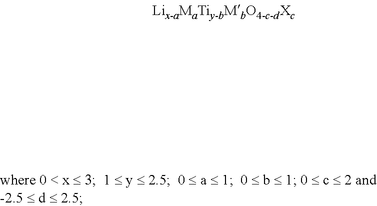

M is at least one element chosen from the group formed by Na, K, Mg, Ca, B, Mn, Fe, Co, Cr, Ni, Al, Cu, Ag, Pr, Y and La;
M′ is at least one element chosen from the group formed by B, Mo, Mn, Ce, Sn, Zr, Si, W, V, Ta, Sb, Nb, Ru, Ag, Fe, Co, Ni, Zn, Al, Cr, La, Pr, Bi, Sc, Eu, Sm, Gd, Ti, Ce, Y and Eu;
X is at least one element chosen from the group formed by S, F, Cl and Br;
The subscript d represents an oxygen vacancy. The subscript d can be lower than or equal to 0.5;
Such as Li₄Ti₅O₁₂, Li₂TiO₃, ramsdellite Li₂Ti₃O₇, LiTi₂O₄, LiTi₂O₄, with 0<x≤2 and Li₂Na₂Ti₆O₁₄, more particularly Li₄₋ₐMₐTi_{5-b}M′_{b}O₄, for example Li₄Ti₅O₁₂ (or Li_{4/3}Ti_{5/3}O₄).

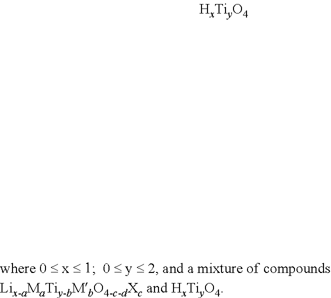

Examples of lithiated titanium oxides are spinel Li₄Ti₅O₁₂, Li₂TiO₃, ramsdellite Li₂Ti₃O₇, LiTi₂O₄, LiₓTi₂O₄, with 0<x≤2 and Li₂Na₂Ti₆O₁₄.

One preferred LTO compound has the formula Li₄₋ₐMₐTi_{5-b}M′_{b}O₄, for example Li₄Ti₅O₁₂ which can also be written Li_{4/3}Ti_{5/3}O₄.

The active material of the positive electrode is not particularly limited. It can be chosen from the following groups or mixtures thereof:
a compound (a) of formula LiₓM_{1-y-z-w}M′_{y}M″_{z}M′″_{w}O₂ (LMO2) where M, M′, M″ and M′″ are chosen from the group formed by B, Mg, Al, Si, Ca, Ti, V, Cr, Mn, Fe, Co, Ni, Cu, Zn, Y, Zr, Nb, W and Mo provided that at least M or M′ or M″ or M′″ is chosen from among Mn, Co, Ni, or Fe; M, M′, M″ and M′″ differing from each other; and 0.8≤x≤1.4; 0≤y≤0.5; 0≤z≤0.5; 0≤w≤0.2 and x+y+z+w<2.1;
a compound (b) of formula LiₓMn_{2-y-z}M′_{y}M″_{z}O₄ (LMO), where M′ and M″ are chosen from the group formed by B, Mg, Al, Si, Ca, Ti, V, Cr, Fe, Co, Ni, Cu, Zn, Y, Zr, Nb and Mo; M′ and M″ differing from each other, and 1≤x≤1.4; 0≤y≤0.6; 0≤z≤0.2;
a compound (c) of formula LiₓFe_{1-y}M_{y}PO₄ (LFMP) where M is chosen from the group formed by B, Mg, Al, Si, Ca, Ti, V, Cr, Mn, Co, Ni, Cu, Zn, Y, Zr, Nb and Mo; and 0.8≤x≤1.2; 0≤y≤0.6;
a compound (d) of formula LiₓMn_{1-y-z}M′_{y}M″_{z}PO₄ (LMP), where M′ and M″ differ from each other and are chosen from the group formed by B, Mg, Al, Si, Ca, Ti, V, Cr, Fe, Co, Ni, Cu, Zn, Y, Zr, Nb and Mo, with 0.8≤x≤1.2; 0≤y≤0.6; 0≤z≤0.2;
a compound (e) of formula xLi₂MnO₃; (1-x)LiMO₂ where M is at least one element chosen from among Ni, Co and Mn and x≤1.
a compound (f) of formula Li₁₊ₓMO_{2-y}F_{y} of cubic structure where M is at least one element chosen from the group formed by Na, K, Mg, Ca, B, Sc, Ti, V, Cr, Mn, Fe, Co, Ni, Cu, Zn, Al, Y, Zr, Nb, Mo, Ru, Ag, Sn, Sb, Ta, W, Bi, La, Pr, Eu, Nd and Sm and where 0≤x≤0.5 and 0≤y≤1.

A conductive element can also be added for preparing a positive electrode. It can be chosen from among electronically conductive materials such as graphite, carbon black, acetylene black, soot, graphene, carbon fibers, carbon nanotubes or a mixture thereof.

The preparation of the pre-mix can be obtained by simply mixing the constituents, typically in powder form, under agitation.

The mixing step can advantageously be carried out at a temperature between 25° C. and the degradation temperature of the fluoropolymer.

By «co-binder» it is meant a material affording the electrode with cohesion of the different components and imparting mechanical strength thereto on the current collector and/or providing the electrode with some flexibility for insertion in a cell. More particularly, the co-binder of the invention ensures cohesion between the fluoropolymer and the active material.

In one embodiment, the co-binder is chosen from among thermoplastic polyurethane (TPU), poly(styrene-butadiene-styrene) (SBS), poly(styrene-ethylene-butadiene-styrene) (SEBS), thermoplastic elastomers (TPE), thermoplastic vulcanizates (TPV), thermoplastic copolyesters (TPC), polystyrene-b-poly(ethylene-butylene)-b-polystyrene (SEBS), the copolymers of acrylonitrile-butadiene also called «nitrile rubbers» (NBR), the hydrogenated copolymers of acrylonitrile-butadiene, also called «hydrogenated nitrile rubbers» (HNBR), elastomers, thermoplastics or ethylene-acrylate terpolymers.

More particularly, the co-binder is TPU.

By «extrusion» it is meant a thermomechanical process whereby the formulation is forced to pass through a die, under the action of pressure and heat.

The extrusion step can be adapted as a function of several parameters, such as mixture temperature, type of profile of the extruder screw, type of extruder die, speed of rotation and/or length of the screws.

In one embodiment, extrusion can be carried out with an extruder of single- or twin-screw type, whether or not co-rotating.

In one embodiment, the screw profile used in the extruder is of shearing type to cause the fluoropolymer to fibrillate in the extruder. The screw profile may have one or more mixing zones. The number of mixing zones is typically dependent upon the number of feed zones. The position of the mixing zones in the extruder generally depends on the number of material feed zones. After each material feed zone, a mixing zone can be added.

Typically, the type of screw element allowing shearing of the material can be adapted to the type of active material contained in the pre-mix. If the active material is sensitive to shear, it is preferable to give priority to elements that are scarcely or moderately shearing. If the active material is little sensitive to shear, it is possible to use elements that are scarcely, moderately, or highly shearing.

The screw rotation speed is generally the same over the entire screw. It is generally recommended to use a rotation speed of between 100 rpm and 1000 rpm, in particular between 100 and 750 rpm. The screw rotation speed is generally adapted as a function of the desired flow rate of material leaving the extruder. The lower the screw rotation speed the slower the output flows. It is to be noted that slow rotation speeds lead to longer residence times in the extruder. In such cases, if the rate of input feed of material is high, major clogging of the extruder may occur. With a fast screw rotation speed, the output flows may fluctuate if the incoming feeds of material are too slow.

The extrusion step can advantageously be conducted at a temperature between 25° C. and the degradation temperature of the fluoropolymer, more particularly between the melting point of the co-binder and the melting point of the fluoropolymer under extrusion conditions, on the understanding that the degradation and/or melt temperatures of the fluoropolymer under the extrusion conditions may be decreased due to applied mechanical stresses. As an illustration, for PTFE, the degradation temperature is about 350° C. and the melt temperature is about 327° C., and taking into account applied stresses the extrusion temperature is preferably lower than or equal to 260° C.

A further subject of the present invention concerns an electrode formulation able to be obtained with the method of the invention.

A further subject of the invention concerns an electrode formulation comprising:
an active electrode material;
a fluoropolymer;
the thermoplastic polyurethane (TPU) as co-binder.

The fluoropolymer is such as defined in the foregoing.

In one embodiment, the aforementioned electrode formulations of the invention may also comprise a conductive element. This is particularly the case for positive electrodes, such as discussed above.

In one embodiment, the electrode formulations of the invention may also comprise one or more additives chosen from among lubricants such as oils or waxes or graphite.

In addition, the formulations of the invention may also comprise a carbon additive. This additive is distributed within the electrode to form an electronic percolating network between the active materials and the current collector.

When present, the carbon can be included up to about 10% (by weight), in particular from 1 to 6% (by weight) of the total weight of the formulation.

Therefore, in one embodiment, the formulations of the invention comprise (by weight):
from 80 to 98.5% active material;
from 0.1 to 5% PTFE;
from 0.1 to 5% TPU;
from 0 to 5% lubricant; and
from 0 to 10% percolating carbon.

The electrode formulation of the invention is suitable for positive or negative electrodes.

The term «negative electrode», when the storage cell is discharging, designates the electrode operating as anode, and when the storage cell is charging it is the electrode operating as cathode, the anode being defined as the electrode at which an electrochemical oxidation reaction takes place (emission of electrons), whilst the cathode is the site of reduction. The term negative electrode also designates the electrode from which the electrons leave, and from which the cations (Li+) are released during discharge.

The term «positive electrode» designates the electrode into which the electrons enter, and at which the cations (Li+) arrive during discharge.

In the invention the electrode formulation is porous, the porosity being imparted by the fluoropolymer fibrils generated by extrusion. This porosity in particular first allows receiving of lithium metal in the porosity of the negative electrode during charge, and secondly allows maintaining of the mechanical strength of the electrode.

By «porous» in the invention it is meant a pore size of less than 300 nm. Pore size corresponds to the structure of the material having an organized network of channels of varying, very small pore size: typically a pore size of less than 1 μm, more preferably less than 300 nm. This pore size imparts the electrode with an active surface area per surface unit of electrode that is particularly high.

In one embodiment, the electrode has porosity of between 10 and 60%, preferably between 15 and 35%, porosity representing the percentage of voids in the total volume of the formulation under consideration. Porosity can generally be measured by Hg porosimetry or Helium porosimetry.

A still further subject of the invention concerns an electrode comprising the formed electrode formulation of the invention.

In one embodiment, said electrode can be composed of a conductive substrate used as current collector which is coated with the formed formulation of the invention.

By current collector it is meant an element such as a pad, sheet, foil or other in conductive material connected to the positive or negative electrode, and ensuring the conducting of the flow of electrons between the electrode and the battery terminals.

The current collector is preferably a two-dimensional conductive substrate such as solid or perforated foil, metal-based for example in copper, nickel, steel, stainless steel or in aluminum.

Said electrode can in particular be an electrode of Li-ion type.

If it is a negative electrode of Li-ion type, it is advantageously composed of the formulation comprising PTFE, TPU and graphite formed on a current collector such as a copper foil.

If it is a positive electrode, it is advantageously composed of the formulation comprising PTFE, TPU, a positive active electrode material, an electronically conductive element and a carbon additive, formed on a current collector such as an aluminum foil.

The electrode of the invention can be prepared by applying or adapting conventional methodologies for fabricating electrodes.

Therefore typically, the formulation obtained after the extrusion step is shaped, for example by pressing, to obtain a self-supporting formulation which can be laminated by calendaring for example onto the current collector.

A further subject of the present invention concerns an electrochemical element comprising at least one electrode of the invention.

By «electrochemical element» it is meant an elementary electrochemical cell formed by the positive electrode/electrolyte/negative electrode assembly, allowing the storage of electrical energy provided by a chemical reaction and restitution thereof in the form of a current.

The chemical elements of the invention can be adapted to different battery technologies and types of electrolytes.

For example, in one embodiment the electrochemical element can be of Lithium-ion type.

Li-ion elements are based on the reversible exchange of the lithium ion between a positive electrode and a negative electrode, separated by an electrolyte, the lithium being deposited at the negative electrode during charge operation. Typically, for these storage cells, the positive electrode formulation comprises a lithiated transition metal oxide as active material, and the negative electrode formulation comprises graphite as active material.

In one embodiment, the electrochemical element can also be of «solid» type or of «Primary Li» type.

The term «solid» designates elements with solid electrolyte, such as oxides halides, sulfides, or a polymer.

The term «Primary Li-» designates a non-rechargeable lithium element.

A further subject of the present invention concerns an electrochemical module comprising the stacking of at least two elements of the invention, each element being electrically connected with one or more other elements.

The term «module» herein therefore designates the assembly of several electrochemical elements, said assemblies possibly being in series and/or parallel.

A still further subject of the invention is a battery comprising one or more modules of the invention.

By «battery» or storage cell, it is meant the assembly of several modules of the invention.

In one embodiment, the batteries of the invention are storage cells having a capacity greater than 100 mAh, typically of 1 to 100 Ah.

### BRIEF DESCRIPTION OF THE DRAWINGS

FIG. 1 is SEM image of the structure of an anode having the formulation 94% Graphite/2% PTFE/4% TPU prepared according to the examples.

FIG. 2 gives the comparison of pore size distribution between a reference anode (represented by circles) and anodes of the invention (varying by their PTFE or TPU content) (samples 1, 2 and 3 represented by squares, diamonds, and triangles respectively).

FIG. 3 gives the comparison of porosity percentage between a reference anode (circles) and anodes of the invention (varying by their PTFE or TPU content) (samples 1, 2 and 3 represented by squares, diamonds, and triangles respectively).

### EXAMPLES

### 1. Preparation of the Electrodes

Electrode formulations of the invention were prepared by forming a pre-mix of the active material (graphite) and fibrillable PTFE. The prepared pre-mix was mixed with the co-binder (TPU) using a twin-screw extruder at a temperature of between 70 and 260° C. and at a rotation speed of between 100 and 750 rpm.

The following formulations were prepared:

TABLE 1

| | Formulations (wt. %/weight of formulation) | | |
|---|---|---|---|
| Parameter | Pre-mix 1 | Pre-mix 2 | Pre-mix 3 |
| Active | 90.25 | 94.6 | 93.6 |
| material | | | |
| (graphite) | | | |
| Fibrillable | 4.75 | 1.4 | 1.4 |
| binder | | | |
| (PTFE) | | | |
| Co-binder | 5 | 4 | 5 |
| (PTU) | | | |

The mixture output from the extruder was collected and transferred to a mixer with external rollers to fabricate a self-supporting electrode (or pressed under a press) and to shape the electrode. Adhesion on a foil was obtained by co-lamination (by calendering) onto a current collector.

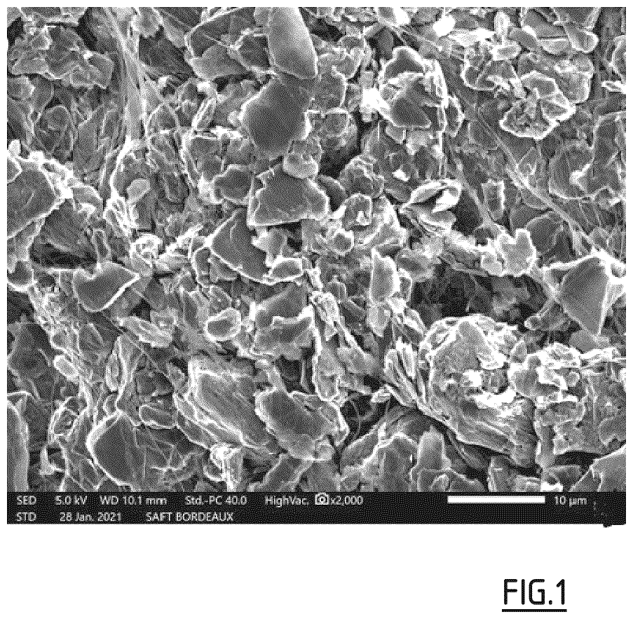

The SEM image in FIG. 1 shows that the PTFE fibrils are well distributed within the electrode. They form a network which contributes towards the formation of porosities within the electrode.

### 2. Characterization of the Electrodes

2.1 the Porosity of the Electrodes Obtained in Example 1 was Analyzed for the Different Compositions, and Compared with that of a Reference Electrode.

### Porosity was Measured by Hg Porosimetry.

The reference electrode was formed by solvent route. The active material (graphite), the binder (SBR) and co-binder (CMC), all in powder form, were first mixed by dry process using a mixer of planetary type. A solvent (NMP) was then added to produce an ink. This ink was coated onto a current collector of copper type. The solvent was then evaporated using a system allowing the solvent to be aspirated and recycled. The formulation of the reference electrode was composed of 97% active material, 1.5% binder and 1.5% de co-binder. The weight ratio of pre-mix/solvent when adding the solvent was 40:60.

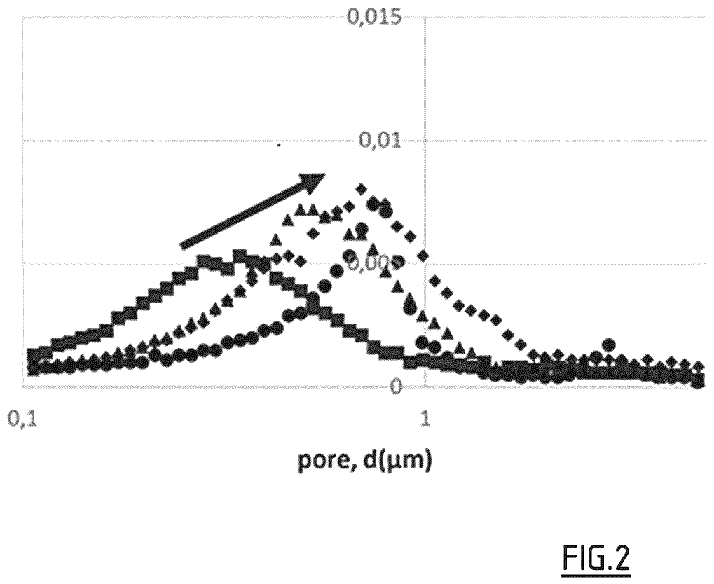

In the graphs in FIG. 2, the reference electrode is represented by circles, and the above formulations of the invention 1, 2 and 3 are represented by squares, diamonds and triangles respectively.

FIG. 2 illustrates the pore size distribution in the reference electrode and in the electrodes prepared with the present invention. Two populations of pores are observed. It can be seen that the pore size distribution in the electrodes prepared with the method described in this invention lies within the range of the pore size of the reference electrode prepared via a standard route (solvent route). In addition, FIG. 2 shows that by changing the amount of PTFE and co-binder (here TPU) in the specific formulation, it is possible to control and modulate the percentage porosity produced but also the mean size of the pores of the electrode.

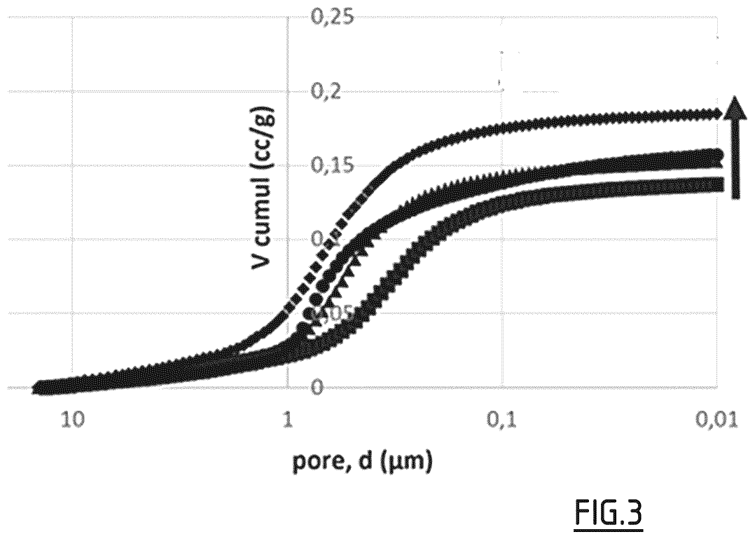

FIG. 3 shows the percentage porosity of the reference electrode prepared via solvent route, and of the electrodes prepared with the method described in the present invention. It can be seen that the percentage porosity of the electrodes prepared with the described method is dependent on the formulation. In addition, it is shown that it is possible to modulate percentage porosity of the electrode by acting on the formulation, namely the content of active material, binder, and co-binder.

### 2.2 Lifetime

The experiments conducted showed a lifetime longer than 30 cycles, at 60° C. and at C/5 discharge rate.

1. A method for preparing an electrode formulation, comprising:
preparing a pre-mix comprising an active electrode material and a fluoropolymer;
mixing the pre-mix with a co-binder;
fibrillating the mixture obtained by extrusion.

2. The method according to claim 1, such that extrusion is performed with an extruder of single- or twin-screw type.

3. The method according to claim 1 such that the fluoropolymer is chosen from among polytetrafluoroethylene (PTFE) and copolymers thereof such as chlorofluoroethylene, perfluoroalkoxy (PFA), polychlorotrifluoroethylene (PCTFE or PTFCE), fluorinated ethylene propylene (FEP), ethylene tetrafluoroethylene or poly(ethylene-co-tetrafluoroethylene) (ETFE), tetrafluoroethylene perfluoro methylvinylether (MFA).

4. The method according to claim 1 such that the fluoropolymer is PTFE.

5. The method according to claim 1 such that the co-binder is chosen from among thermoplastic polyurethane (TPU), poly(styrene-butadiene-styrene) (SBS), poly(styrene-ethylene-butadiene-styrene) (SEBS), thermoplastic elastomers (TPE), thermoplastic vulcanizates (TPV), thermoplastic copolyesters (TPC), polystyrene-b-poly(ethylene-butylene)-b-polystyrene (SEBS), copolymers of acrylonitrile-butadiene also called «nitrile rubbers» (NBR), the hydrogenated copolymers of acrylonitrile-butadiene also called «hydrogenated nitrile rubbers» (HNBR), elastomers, thermoplastics or ethylene-acrylate terpolymers.

6. The method according to claim 1, such that the co-binder is TPU.

7. The method according to claim 1 such that the mixing step under mechanical stress is performed at a temperature of between 25° C. and the degradation temperature of the fluoropolymer.

8. An electrode formulation able to be obtained with the method according claim 1.

9. An electrode formulation of Li-ion type, comprising:
an active electrode material;
a fluoropolymer;
the thermoplastic polyurethane (TPU) as co-binder.

10. The formulation according to claim 9, such that it further comprises a conductive element.

11. The formulation according to claim 9, such that it comprises (by weight):
from 80 to 98.5% active material;
from 0.1 to 5% PTFE;
from 0.1 to 5% TPU;
from 0 to 5% lubricant; and
from 0 to 10% percolating carbon.

12. The formulation according to claim 8 having porosity of between 15 and 35%.

13. An electrode of Li-ion type comprising the electrode formulation according to claim 8, formed on a current collector.

14. The electrode according to claim 13, such that it is a negative electrode and such that the formulation comprises PTFE, TPU, graphite.

15. An electrochemical element of Li-ion type comprising an electrode according to claim 13.
